(19) United States
(12) Patent Application Publication
(10) Pub. No.: US 2024/0121362 A1
(43) Pub. Date: Apr. 11, 2024

(54) CAMERA MONITORING SYSTEM INCLUDING TRAILER MONITORING VIDEO COMPRESSION

(71) Applicants: Banuprakash Murthy, Novi, MI (US); Troy Otis Cooprider, White Lake, MI (US)

(72) Inventors: Banuprakash Murthy, Novi, MI (US); Troy Otis Cooprider, White Lake, MI (US)

(21) Appl. No.: 18/376,603

(22) Filed: Oct. 4, 2023

Related U.S. Application Data
(60) Provisional application No. 63/413,703, filed on Oct. 6, 2022.

(51) Int. Cl. H04N 7/18; H04N 5/262; H04N 19/136; H04N 19/42; H04N 19/85; H04N 23/90

(52) U.S. Cl. CPC H04N 7/181; H04N 5/2624; H04N 19/136; H04N 19/42; H04N 19/85; H04N 23/90

(57) ABSTRACT

An example method for reducing video transmission bandwidth includes receiving a plurality of video feeds from a plurality of cameras disposed on a vehicle including a cab and a trailer. Each of the video feeds has a distinct field of view. The plurality of video feeds are stitched into a single stitched video feed. The stitched video feeds are compressed into a compressed data stream. The compressed data stream is transmitted to at least one remote system. The stitched video feeds are decompressed.

### TECHNICAL FIELD

This disclosure relates to a camera monitoring system (CMS) for a vehicle, and specifically to a process for transmitting video feeds from a vehicle to one or more remote systems.

### BACKGROUND

Camera monitoring systems (CMS) such as mirror replacement systems, and camera systems for supplementing mirror views, are utilized in vehicles to enhance the ability of a vehicle operator to see a surrounding environment during operation of the vehicle. Camera monitoring systems utilize one or more cameras to provide an enhanced field of view to a vehicle operator. In some examples, the camera monitoring systems cover a larger field of view than a corresponding conventional mirror, or include views that are not fully obtainable via a conventional mirror.

In addition to mirror replacement, the images provided via the cameras in the CMS can be utilized to monitor the environment and the vehicle on an on-going basis while the vehicle is not being operated. In some examples, the views captured by the CMS during this monitoring can provide benefits outside of vehicle operations when provided to remote systems. However, providing multiple video views to remote systems utilizes substantial amounts of bandwidth to transmit each of the videos. The amount of bandwidth required to transmit the full resolution of every independent video can be technologically prohibitive and/or economically prohibitive at the timescale required of the remote system(s).

### SUMMARY

An example method for reducing video transmission bandwidth includes receiving a plurality of video feeds from a plurality of cameras disposed on a vehicle including a cab and a trailer. Each of the video feeds has a distinct field of view. The plurality of video feeds are stitched into a single stitched video feed. The stitched video feeds are compressed into a compressed data stream. The compressed data stream is transmitted to at least one remote system. The stitched video feeds are decompressed.

Each of the distinct fields of view may include at least a portion of one of a vehicle cab and a vehicle trailer.

Stitching the plurality of video feeds into the single stitch video feed may further include incorporating a stitching data segment into the single stitched video feed.

The stitching data segment may include information configured to allow at least one remote system to at least partially destitch the single stitched video feed.

Compressing the stitched video feeds into a single stitched video feed may include applying a lossy encoding to the single stitched video feed.

The lossy encoding may be an H 264 encoder.

Transmitting the compressed data stream to the at least one remote system may include transmitting the compressed data stream directly to at least one of a security system, a surveillance system, and an insurance monitoring system.

Transmitting the compressed data stream to the at least one remote system may include transmitting the compressed data stream to one of a central server and a cloud computing system, and wherein the at least one remote system accesses the one of the central server and the cloud computing system.

Stitching the plurality of video feeds into a single stitched video feed may include joining static edges of the video feeds as stitching interfaces such that each video feed shares an edge with at least one other video feed in the single stitched video feed.

Each of the plurality of video feeds in the stitched video feed may be a regular geometric figure.

At least one of the stitching interfaces may be algorithmically created such that the joined video feeds are irregular geometric figures.

At least one of the plurality of video feeds may be a class VIII video feed.

In some aspects, the techniques described herein relate to a camera monitoring system (CMS) including a plurality of cameras disposed about a vehicle. Each camera is configured to generate a video feed having distinct view. A controller may include a memory and a processor. The controller is configured to receive each video feed. The memory stores instructions for causing the processor to stitch the plurality of video feeds into a single stitched video feed, to compress the stitched video feeds into a compressed data stream, to transmit the compressed data stream to at least one remote system, and to decompress the stitched video feeds.

At least one camera may generate a class VIII view.

The compressed data stream may be compressed via a lossy encoder.

The lossy encoder may be a H.264 encoder.

The compressed data stream may include stitching information configured to allow at least one remote system to at least partially destitch the single stitched video feed.

### BRIEF DESCRIPTION OF THE DRAWINGS

The disclosure can be further understood by reference to the following detailed description when considered in connection with the accompanying drawings wherein:

FIG. 1A is a schematic front view of a commercial truck with a camera monitoring system (CMS) used to provide at least Class II and Class IV views.

FIG. 1B is a schematic top elevational view of a commercial truck with a camera monitoring system providing Class II, Class IV, Class V and Class VI views.

FIG. 2 is a schematic top perspective view of a vehicle cabin including displays and interior cameras.

FIG. 3 illustrates an exemplary method for compressing multiple video feeds.

FIG. 4 schematically illustrates a first stitched video feed.

FIG. 5 schematically illustrates a second stitched video feed, including a de-stitching information segment.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

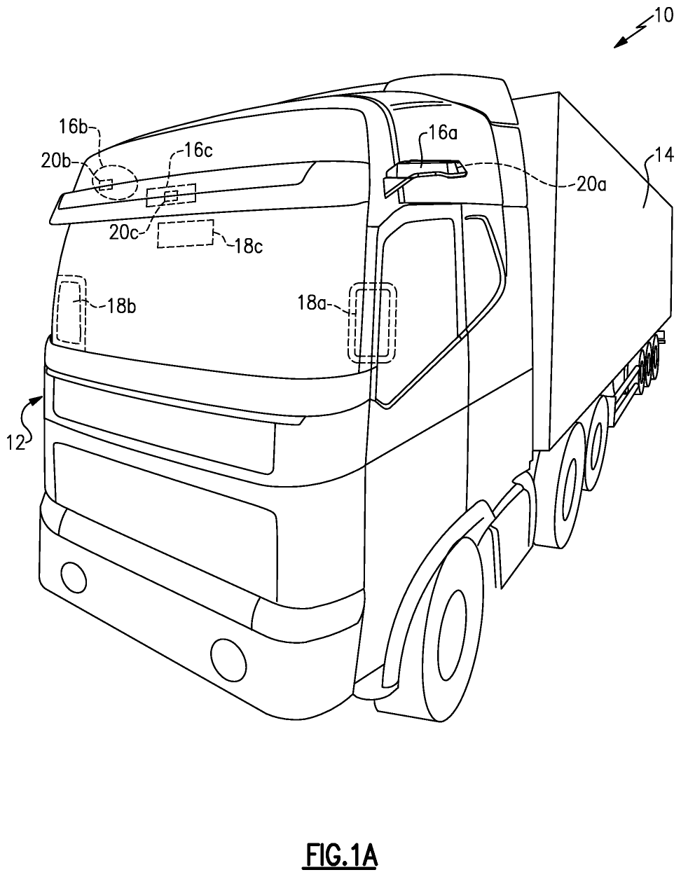

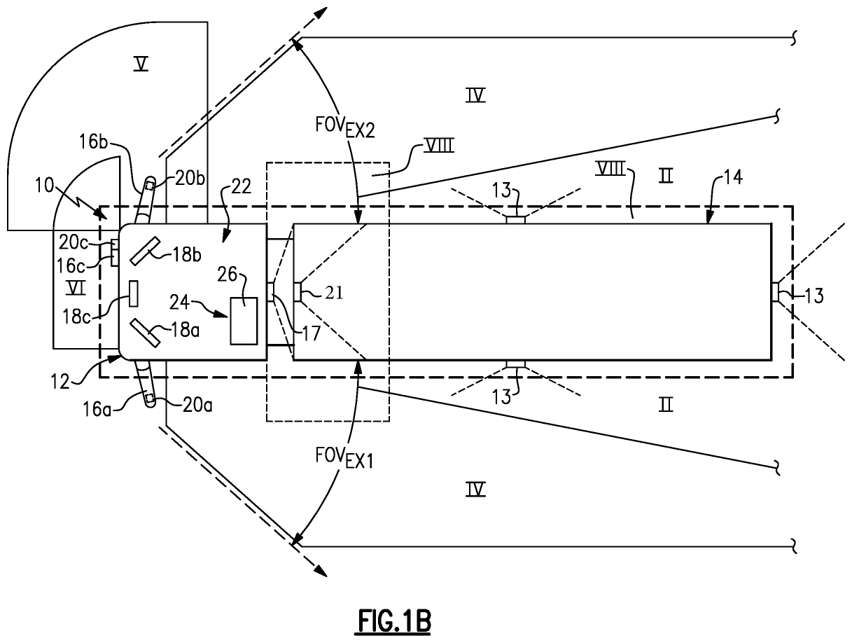

A schematic view of a commercial vehicle 10 is illustrated in FIGS. 1A and 1B. FIG. 2 is a schematic top perspective view of the vehicle 10 cabin including displays and interior cameras. The vehicle 10 includes a vehicle cab or tractor 12 for pulling a trailer 14. It should be understood that the vehicle cab 12 and/or trailer 14 may be any configuration. Although a commercial truck is contemplated in this disclosure, the invention may also be applied to other types of vehicles. The vehicle 10 incorporates a camera monitor system (CMS) 15 (FIG. 2) that has driver and passenger side camera arms 16a, 16b mounted to the outside of the vehicle cab 12. If desired, the camera arms 16a, 16b may include conventional mirrors integrated with them as well, although the CMS 15 can be used to entirely replace mirrors. In additional examples, each side can include multiple camera arms, each arm housing one or more cameras and/or mirrors.

Each of the camera arms 16a, 16b includes a base that is secured to, for example, the cab 12. A pivoting arm is supported by the base and may articulate relative thereto. At least one rearward facing camera 20a, 20b is arranged respectively within camera arms. The exterior cameras 20a, 20b respectively provide an exterior field of view FOVEX1, FOVEX2 that each include at least one of the Class II and Class IV views (FIG. 1B), which are legal prescribed views in the commercial trucking industry. Multiple cameras also may be used in each camera arm 16a, 16b to provide these views, if desired. Class II and Class IV views are defined in European R46 legislation, for example, and the United States and other countries have similar drive visibility requirements for commercial trucks. Any reference to a “Class” view is not intended to be limiting, but is intended as exemplary for the type of view provided to a display by a particular camera. Each arm 16a, 16b may also provide a housing that encloses electronics that are configured to provide various features of the CMS 15.

In one example, in addition to the cameras 20a, 20b in the camera arms 16a, 16b, the CMS 15 includes at least a rear facing camera 60, and an internal trailer camera 62. The rear facing camera 60 captures a view of the exterior of the trailer 14, while the interior camera 62 captures a view of the interior of the trailer 14, including objects that are loaded into the trailer 14. In alternate examples, either camera 60, 62 can be a camera incorporated in a secondary system connected to the CMS 15, and configured to provide video feed to the CMS 15, and the following description can function similarly.

First and second video displays 18a, 18b are arranged on each of the driver and passenger sides within the vehicle cab 12 on or near the A-pillars 19a, 19b to display Class II and Class IV views on its respective side of the vehicle 10, which provide rear facing side views along the vehicle 10 that are captured by the exterior cameras 20a, 20b.

If video of Class V and/or Class VI views are also desired, a camera housing 16c and camera 20c may be arranged at or near the front of the vehicle 10 to provide those views (FIG. 1B). A third display 18c arranged within the cab 12 near the top center of the windshield can be used to display the Class V and Class VI views, which are toward the front of the vehicle 10, to the driver. The displays 18a, 18b, 18c face a driver region 24 within the cabin 22 where an operator is seated on a driver seat 26. The location, size and field(s) of view streamed to any particular display may vary from the configurations described in this disclosure and still incorporate the disclosed invention.

If video of Class VIII views is desired, camera housings can be disposed at the sides and rear of the vehicle 10 to provide fields of view including some or all of the Class VIII zones of the vehicle 10. In such examples, the third display 18c can include one or more frames displaying the Class VIII views. Alternatively, additional displays can be added near the first, second and third displays 18a, 18b, 18c and provide a display dedicated to providing a Class VIII view.

In some examples, the tractor 12 and the trailer 14 can include additional cameras 13, 17, 21 for providing views including the outside of the trailer 14. Cameras 13, on the sides of the trailer 14, and camera 17, on the tractor 12, capture a view of the exterior of the trailer 14. Similarly, a camera 21 captures a view of the interior of the trailer 14. Each of the prescribed Class views, as well as the views from the additional cameras 13, 17, 21 and/or any other additional cameras on the vehicle 10, can provide important and/or valuable non-operational video feeds regarding the trailer 14. As used herein, non-operational video feeds refers to any video feed(s) that are beneficial to a system or process that is not used to assist with operation of the vehicle. By way of example, alarm systems, load monitoring systems, insurance reviews, or any other system that does not run during the operation of the vehicle. Each of the non-operational systems is remote from the vehicle 10 and uses the video feeds gathered by the cameras in a different way.

In one, an insurance monitoring system stores the video feeds in a database, along with a time index. When an insurance claim is issued, the insurance monitoring system retrieves the video feed immediately before the claimed incident up through the incident, and the claim can be reviewed to determine accuracy and/or liability. This example does not utilize real time uploads or monitoring, and can be uploaded from the vehicle to an insurance database periodically.

In another example, the video can be utilized by a trailer surveillance system. In such an example, the video feeds from the additional cameras 13, 17, 21 as well as from the cameras providing the Class VIII view are provided to the surveillance system and are automatically or manually monitored while the vehicle 10 is not operating. In one case, this monitoring is provided between engine cycles while the vehicle 10 is transporting cargo. In another case, the monitoring occurs while the vehicle 10 is parked in a loading bay or loading dock after being loaded and before beginning transportation of the cargo. Similarly, the surveillance system can be used after the while the vehicle 10 is unloading and after the vehicle 10 has unloaded.

In another example, the video can be utilized with a security system, wherein the video feed is continuously monitored for specific triggering conditions while the vehicle 10 is not being operated and/or no operator is present with the vehicle 10.

While specific systems are enumerated above, it is appreciated that the process for compressing multiple video feeds can be utilized in conjunction with any remote system configured to use one or more of the video feeds, and that the compressed video feeds can be provided to multiple remote systems either directly, or indirectly through a cloud computing system or a central server.

To facilitate each of these uses, the video feeds are provided from the vehicle to a remote system either via a wireless communication system (e.g., a cellular data network), a direct physical connection, or any other data connection. On its own, each uncompressed video feed utilizes substantial amounts of bandwidth when being transmitted to the remote systems.

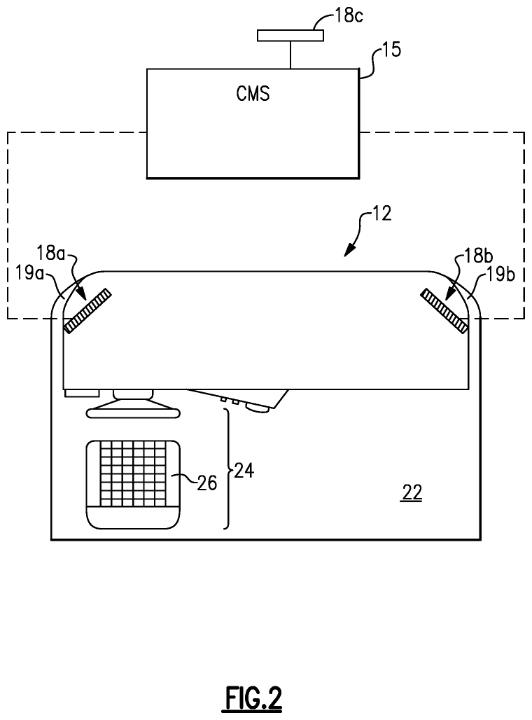

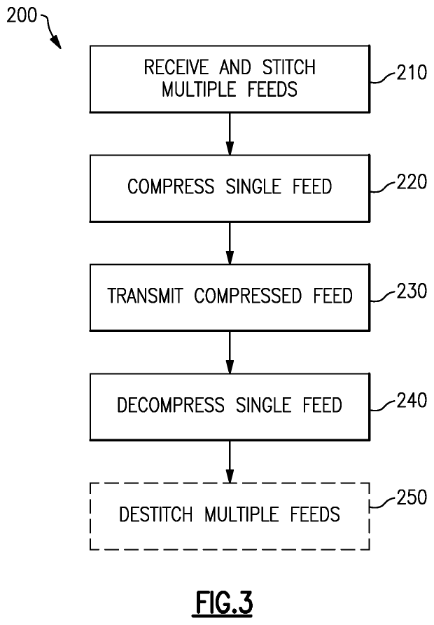

In order to reduce the bandwidth utilized, and improve the transmission times and minimize transmission delay, the CMS 15 utilizes a compression process to consolidate each of multiple distinct videos into a single video feed, and compresses the single video feed. With continued reference to FIG. 1A to FIG. 3, FIG. 4 illustrates the process 200. Once the single feed is compressed, the compressed feed is transmitted to the remote system which can uncompressed the feed and analyze the video in the manner most appropriate for the particular system receiving the feed. In some examples, the feed can be transmitted directly to the system utilizing the videos. In other examples, the feed can be transmitted to a cloud based system where it is retrieved by one or more remote systems configured to use the feed.

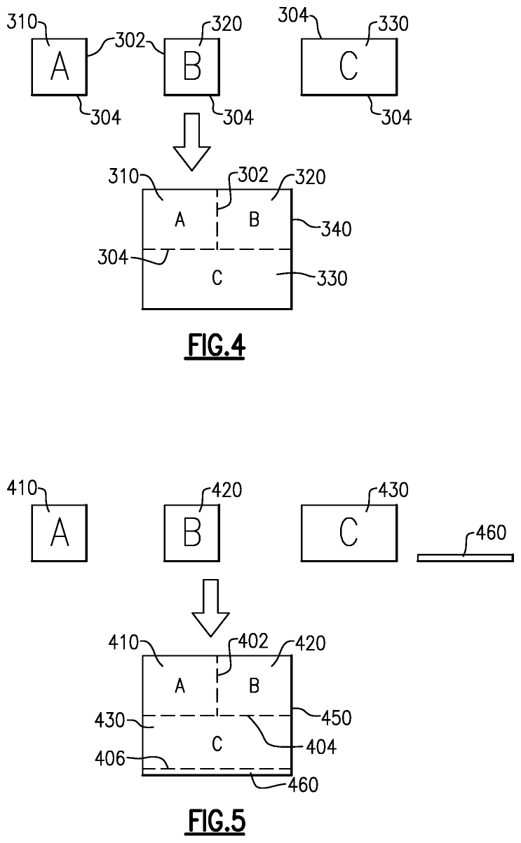

An initial “Receive and Stitch Multiple Feeds” step 210 of the transmission process occurs when the CMS 15 stitches the video feeds together into a single video feed. In some examples, the stitching can be a joining of the edge lines of each video feed together to form a single larger framed video feed (as exemplified in FIGS. 4 and 5). In other examples, the feeds can be resized and/or intelligently stitched together to create a “scene” that is more comprehensible to a human viewer and/or provides a format more easily analyzable by an automated system. In such examples, the stitching can use AI to create a scene connecting corresponding portions of the vehicle, tracking objects or elements as they pass through the various camera feeds, or any similar image stitching process. In some further examples, the stitching can include a portion for “stitching data”, and the stitching data allows a subsequent system to separate all, or a part of, the stitched video feed into its original segment. This is referred to as de-stitching or partially de-stitching the compressed feed.

Once stitched into a single video feed, the feed is compressed in a “Compress Single Feed” step 220 using a video compression algorithm such as H.264 video encoding. The compression reduces the amount of bandwidth required to transmit the video feed. Typically, video encoding can be in either a “lossless” or “lossy” compression form (lossless or lossy encoding). In lossless encoding, the compression of the data is such that the feed can be completely reconstructed up to the pre-compression resolution. Lossy encoding, on the other hand, includes irreversible compression that is unable to be fully reconstructed. By way of example, H.264 is typically a lossy compression. Furthermore, lossy compression algorithms tend to provide substantially more compression than lossless algorithms. The instant process 200 benefits from the fact that none of the remote systems require the full resolution of any given video feed, and a lossy compression algorithm can be utilized instead of a lossless compression algorithm.

After compressing the single stitched feed, the CMS 15 transmits the compressed video feed in a “transmit compressed feed” step 230. By stitching the video feeds into a single feed and compressing the single feed, the required bandwidth to transmit the video feed is substantially reduced. This reduction is further improved by using the lossy compression algorithm. The transmission can be received directly by one or more remote systems and a remote server, or can be transmitted to a cloud computing system. If transmitted to a remote server or a cloud computing system, any remote systems needing some or all of the video feed can access the feed from the remote server or the cloud computing system.

Each of the remote systems accessing the video feed can then Decompress the video into a viewable and analyzable form in an “Decompress Single Feed” step 240. In some examples, the single video feed can include, or be accompanied by, a frame or segment of data defining stitching information. The stitching information includes locations of stitching interfaces, as well as sufficient information to allow a subsequent system to separate all, or a portion, of the stitching information into distinct decompressed videos. When included, the process 200 can include an optional “De-stitch to Multiple Feeds” Step 250.

With continued reference to FIGS. 1A-3, FIG. 4 schematically illustrates an exemplary stitching of three individual video feeds 310, 320, 33 into a single video feed 340. To stitch the frames 310, 320, 330 together, a right edge of the first frame 310 and a left edge of the second frame 320 are joined as a first stitching interface 302. Similarly, a bottom edge of the first and second frames 310, 320 are joined with a top edge of the third frame 330 via a second stitching interface 304. The resultant single video frame 340 can be compressed and transmitted as a single data stream.

In some examples, the frame 340 of FIG. 4 can be modified to include an additional stitching data segment 460 as shown in FIG. 5. The stitching data segment 460 includes data identifying the positioning of the stitching interfaces 402, 404 joining the videos 410, 420, 430 as well as a third stitching interface 406 connecting the stitching data segment 460 to the bottom edge of the third frame 450. In alternative configurations, the data contained in the stitching segment 460 can be presented as a frame at the start, end, or periodically within the data transmission. In each case, the stitching information 460 defines the stitching interface positions, and how the portions of the video feed 450 can be destitched either entirely or partially.

It is appreciated that the example stitching of FIGS. 4 and 5 is purely illustrative. In alternative examples, the number of video feeds stitched together can vary and the shapes of the stitching interfaces can be regular geometric shapes, irregular geometric shapes, including curved edges, adaptive stitching interfaces, or any combination thereof. It is further appreciated that the more complex the stitching, and the greater number of video feeds stitched together, the greater the amount of information that would be required to be transmitted to facilitate a destitching operation.

Although an example embodiment has been disclosed, a worker of ordinary skill in this art would recognize that certain modifications would come within the scope of the claims. For that reason, the following claims should be studied to determine their true scope and content.

What is claimed is:

1. A method for reducing video transmission bandwidth comprising:
receiving a plurality of video feeds from a plurality of cameras disposed on a vehicle including a cab and a trailer, each of the video feeds having a distinct field of view;
stitching the plurality of video feeds into a single stitched video feed;
compressing the stitched video feeds into a compressed data stream;
transmitting the compressed data stream to at least one remote system; and
decompressing the stitched video feeds.

2. The method of claim 1, wherein each of the distinct fields of view includes at least a portion of one of a vehicle cab and a vehicle trailer.

3. The method of claim 1, wherein stitching the plurality of video feeds into the single stitch video feed further includes incorporating a stitching data segment into the single stitched video feed, and wherein the stitching data segment includes information configured to allow at least one remote system to at least partially destitch the single stitched video feed.

4. The method of claim 1, wherein compressing the stitched video feeds into a single stitched video feed comprises applying a lossy encoding to the single stitched video feed.

5. The method of claim 4, wherein the lossy encoding is an H 264 encoder.

6. The method of claim 1, wherein transmitting the compressed data stream to the at least one remote system comprises transmitting the compressed data stream directly to at least one of a security system, a surveillance system, and an insurance monitoring system.

7. The method of claim 1, wherein transmitting the compressed data stream to the at least one remote system comprises transmitting the compressed data stream to one of a central server and a cloud computing system, and wherein the at least one remote system accesses the one of the central server and the cloud computing system.

8. The method of claim 1, wherein stitching the plurality of video feeds into a single stitched video feed comprises joining static edges of the video feeds as stitching interfaces such that each video feed shares an edge with at least one other video feed in the single stitched video feed.

9. The method of claim 8, wherein each of the plurality of video feeds in the stitched video feed is a regular geometric figure.

10. The method of claim 8, wherein at least one of the stitching interfaces is algorithmically created such that the joined video feeds are irregular geometric figures.

11. The method of claim 1, wherein at least one of the plurality of video feeds is a class VIII video feed.

12. A camera monitoring system (CMS) comprising:
a plurality of cameras disposed about a vehicle, each camera being configured to generate a video feed having distinct view;
a controller including a memory and a processor, the controller being configured to receive each video feed and the memory storing instructions for causing the processor to stitching the plurality of video feeds into a single stitched video feed, compressing the stitched video feeds into a compressed data stream, transmitting the compressed data stream to at least one remote system and decompress the stitched video feeds.

13. The CMS of claim 12, wherein at least one camera generates a class VIII view.

14. The CMS of claim 12, wherein the compressed data stream is compressed via a lossy encoder.

15. The CMS of claim 14, wherein the lossy encoder is a H.264 encoder.

16. The CMS of claim 12, wherein the compressed data stream further comprises stitching information configured to allow at least one remote system to at least partially destitch the single stitched video feed.
